(19) United States
(12) Patent Application Publication
(10) Pub. No.: US 2020/0184589 A1
(43) Pub. Date: Jun. 11, 2020

(54) ANALYZING DATA FOR GENERATING CUSTOM EDUCATIONAL PLAN/CONTENT OPTIONS

(71) Applicant: International Business Machines Corporation, Armonk, NY (US)

(72) Inventors: Agueda Martinez Hernandez Magro, Zapopan (MX); Jose R. Mosqueda Mejia, Michoacan (MX); Alejandro Alberto Blumenkron Hurtado, Zapopan (MX); James R. Kozloski, New Fairfield, CT (US)

(21) Appl. No.: 16/212,918

(22) Filed: Dec. 7, 2018

(51) Int. Cl. G06Q 50/20; G06Q 10/06

(52) U.S. Cl. CPC G06Q 50/2057; G06Q 10/063118

(57) ABSTRACT

A system and method that includes identifying a change in condition of a working environment. Educational content relevant to an educational category of the change in condition is retrieved. A skill gap of a team member associated with the working environment is calculated by comparing an existing educational training received by the team member relevant to the educational category with the educational content retrieved in response to identifying the change in condition. A custom education plan is built to resolve the skill gap of the team member.

### TECHNICAL FIELD

The present invention relates to systems and methods for auto-creation of educational content, and more specifically the embodiments of an educational content generation system for building customized educations plans to resolve specific skill gaps.

### BACKGROUND

Current software development methodologies require software development team members to swiftly react to changes in a software development lifecycle management system. For example, team members must automate, plan, and work in response to changes as quickly as possible. Team members have different roles in the software development team and have varying levels of training and education. As a result, responses by software development teams to critical changes in the software development lifecycle management system can vary greatly. Similarly, working environments that include many employees or team members have varying levels of training and education regarding specific issues that result in skill gaps between the employees or team members.

### SUMMARY

An embodiment of the present invention relates to a method, and associated computer system and computer program product, building customized educations plans to resolve specific skill gaps. A processor of a computing system identifies a change in condition of a working environment. Educational content relevant to an educational category of the change in condition is retrieved. A skill gap of a team member associated with the working environment is calculated by comparing an existing educational training received by the team member relevant to the educational category with the educational content retrieved in response to identifying the change in condition. A custom education plan is built to resolve the skill gap of the team member.

### BRIEF DESCRIPTION OF THE DRAWINGS

FIG. 1 depicts a block diagram of an educational content generation system, in accordance with embodiments of the present invention.

FIG. 1A depicts a software lifecycle management system as a working environment, in accordance with embodiments of the present invention.

FIG. 2 depicts a diagram plotting user profile features and skills needed to accomplish a task, in accordance with embodiments of the present invention.

FIG. 3 depicts a flow chart of a method for building customized educations plans to resolve specific skill gaps, in accordance with embodiments of the present invention

FIG. 4 depicts a flow chart of a method for building customized educations plans to resolve specific skill gaps in software development teams in response to a first change in condition to a software development lifecycle management system, in accordance with embodiments of the present invention.

FIG. 5 depicts a flow chart of a method for building customized educations plans to resolve specific skill gaps in software development teams in response to a second change in condition to a software development lifecycle management system, in accordance with embodiments of the present invention

FIG. 6 depicts a flow chart of a method for building customized educations plans to resolve specific skill gaps in software development teams in response to a third change in condition to a software development lifecycle management system, in accordance with embodiments of the present invention

FIG. 7 depicts a flow chart of a method for building customized educations plans to resolve specific skill gaps in software development teams in response to a fourth change in condition to a software development lifecycle management system, in accordance with embodiments of the present invention.

FIG. 8 depicts a block diagram of a computer system for the educational content generation system of FIG. 1, capable of implementing methods for building customized educations plans to resolve specific skill gaps in software development teams of FIGS. 3-6, in accordance with embodiments of the present invention.

FIG. 9 depicts a cloud computing environment, in accordance with embodiments of the present invention.

FIG. 10 depicts abstraction model layers, in accordance with embodiments of the present invention.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

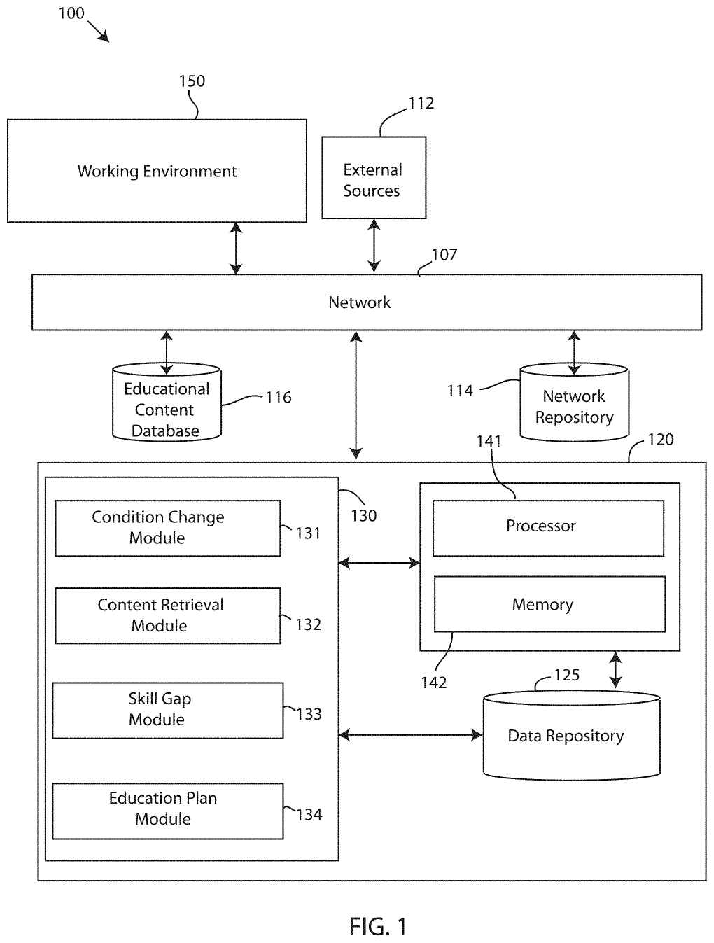

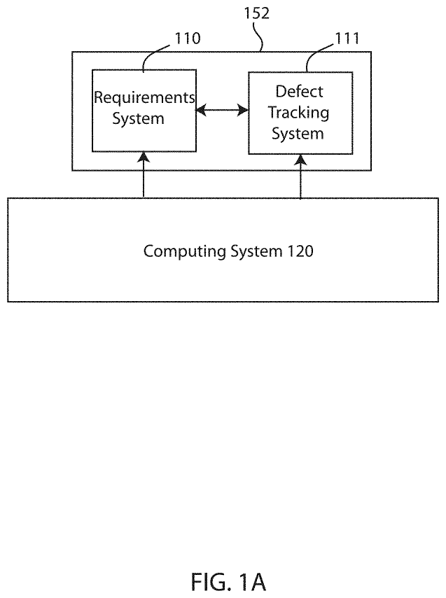

Referring to the drawings, FIG. 1 depicts a block diagram of an educational content generation system 100, in accordance with embodiments of the present invention. The educational content generation system 100 is a system for building customized educations plans to resolve specific skill gaps for members of an organization or team. As an example, the educational content generation system 100 is a system for building customized educations plans to resolve specific skill gaps in software development teams. The software development team can be involved in various projects. In an exemplary embodiment, the software development team operates and/or manages a software development lifecycle management system. The educational content generation system 100 may be useful for resolving skill gaps uniquely tailored to team members of a team, taking into account the team member's role on the team and previously received education and training. Embodiments of the educational content generation system 100 may be alternatively referred to as a skill gap resolution system, a software development response improvement system, a training system, a cognitive team training, a cognitive skill development system, and the like.

The educational content generation system 100 includes a computing system 120. Embodiments of the computing system 120 include a computer system, a computer, a server, one or more servers, a backend computing system, and the like.

Furthermore, the educational content generation system 100 includes a working environment 150, external data sources 112, and an educational content database 116 that are communicatively coupled to the computing system 120 over a network 107. For instance, information/data is transmitted to and/or received from the working environment 150, external data sources 112, and educational content database 116 over a network 107. In an exemplary embodiment, the network 107 is a cloud computing network. Further embodiments of network 107 refer to a group of two or more computer systems linked together. Network 107 includes any type of computer network known by individuals skilled in the art. Examples of network 107 include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. In one embodiment, the architecture of the network 107 is a peer-to-peer, wherein in another embodiment, the network 107 is organized as a client/server architecture.

In an exemplary embodiment, the network 107 further comprises, in addition to the computing system 120, a connection to one or more network-accessible knowledge bases 114, which are network repositories containing information of the team members, roles of the team, past educations plans, past recommendations for training, educational backgrounds of the team members, software development data, etc, which have been collected with the permission of the team member. The network repositories or other systems connected to the network 107 are considered nodes of the network 107. In an embodiment where the computing system 120 or network repositories allocate resources to be used by the other nodes of the network 107, the computing system 120 and network-accessible knowledge bases 114 is referred to as servers.

The network-accessible knowledge bases 114 is a data collection area on the network 107 which backs up and save all the data transmitted back and forth between the nodes of the network 107. For example, the network repository is a data center saving and cataloging, with permission of the team members, roles of the team, past educations plans, past recommendations for training, educational backgrounds of the team members, software development data, etc., and the like, to generate both historical and predictive reports regarding a customized education plan for a particular team member. In an exemplary embodiment, a data collection center housing the network-accessible knowledge bases 114 includes an analytic module capable of analyzing each piece of data being stored by the network-accessible knowledge bases 114. Further, the computing system 120 can be integrated with or as a part of the data collection center housing the network-accessible knowledge bases 114. In an alternative embodiment, the network-accessible knowledge bases 114 are a local repository that is connected to the computing system 120.

The working environment 150 is an environment, workspace, work product, system, and the like that comprises one or more team members for producing a result within the working environment. An example of a working environment is a software development environment, a project, a business unit, a research and development division, a sales department, an organization, a company, and the like. FIG. 1A depicts a software lifecycle management system 152 as a working environment, in accordance with embodiments of the present invention. The software development lifecycle management system 152 includes a requirements system 110 and a defect tracking system, 111, both of which can communicate with each and other and to the computing system 120 over network 107. The requirements system 110 is a software requirements system that contains information about new features or new software requirements that are to be added to the software system under development and/or operative management. New software requirements for a software project are input into the requirements system 110 during ongoing development and management of the software project. The requirements system 110 can be deployed on premises or offered in the cloud in a software as a service (SaaS) environment, and is a web-based solution including visual requirements definition, planning, work item management, and test integration. The requirements system 110 enables a user to capture, trace, analyze, and manage changes to requirements while maintaining compliance to regulations and standards. The defect tracking system 111 manages plans, tasks, project status to enable faster release cycles and manage dependencies across small and complex software development projects. The defect tracking system 111 is a defect system that is used to track and report defects or failures in the software project under development. Moreover, external sources 112 include databases, sources, programs, etc. that are external to the software development lifecycle management system 150 that can be used for developing custom education plans specific for improving the skills of a team member.

The educational content generation system 100 may also include a management system for managing personal and professional data of the team members optionally provided by the team members and/or optionally authorized by the team to transmit to the computing system. The management system contains information about team members (e.g. employees of an organization), personal data, professional data, team member job status, career information, training programs undergone by team members, educational content provided to team members, and the like. The HR management system accesses a profiles database. The profiles database is a database or other storage medium that stores information about current skills for each team member/employee, the team member's profile, the team member's job role, education plan for each team member, and the like. The personal and professional information contained in the profiles database accessed by the management system is collected and/or made available to the computing system 120 only with the knowledge and permission of the team member. The team member can opt in and opt out at any time with respect to data collection, data record availability, data transmission, etc.

Referring back to FIG. 1, the educational content generation system 100 also includes an educational content database 116. The educational content database 116 is an internal database that contains educational assets and content used by team members associated with working environments. Examples of educational content contained by the educational content database 116 includes wikis, presentations, training manuals, videos, handbooks, technical specifications, instructions, and the like.

The computing system 120 of educational content generation system 100 is equipped with a memory device 142 which stores various data/information/code, and a processor 141 for implementing the tasks associated with the educational content generation system 100. An educational content generation application 130 is loaded in the memory device 142 of the computing system 120. The educational content generation application 130 can be an interface, an application, a program, a module, or a combination of modules. In an exemplary embodiment, the educational content generation application 130 is a software application running on one or more back end servers (e.g. computing system 120).

The educational content generation application 130 of the computing system 120 includes a condition change module 131, a content retrieval module 132, a skill gap module 133, and an education plan module 134. A “module” refers to a hardware-based module, a software-based module, or a module that is a combination of hardware and software. Hardware-based modules include self-contained components such as chipsets, specialized circuitry and one or more memory devices, while a software-based module is a part of a program code or linked to the program code containing specific programmed instructions, which is loaded in the memory device of the computing system 120. A module (whether hardware, software, or a combination thereof) is designed to implement or execute one or more particular functions or routines.

The condition change module 131 includes one or more components of hardware and/or software program code for identifying a change in condition of the working environment. A change in condition to the working environment includes a work requirements added to the working environment, a pattern of significance (e.g. number of customer returns, a number of complaints, a number of hardware component failures, bugs resulting from code), an addition of a new team member to the working environment, a role change within the working environment, and the like.

In an exemplary embodiment, the working environment is a lifecycle development management system 152, as shown in FIG. 1A. In this example, the condition change module 131 detects a change in condition of one or more tools of a software development lifecycle management system 150. The one or more tools of the software development lifecycle management system 150 includes the requirements system 110 and the defect tracking system 111, among others not shown in FIG. 1. The condition change module 131 monitors the tools of the software development lifecycle management system 150 to identify any changes to the condition of the software development lifecycle management system 150. A change in condition to the software development lifecycle management system 150 includes a new software requirement be added to the system 150, a defect pattern, an addition of a new team member to the software development team, a role change within the software development team, and the like.

By way of example, the condition change module 131 monitors the system 150 for a new software requirement that has been added to the requirements system 110. The condition change module 131 detects the newly added requirement that triggers content retrieval and skill gap analysis as described in greater detail infra. The condition change module 131 monitors the system 150 for a pattern of valid open defects assigned to a certain developer based on a predetermined number, which implies the developer needs training. Similarly, the condition change module 131 monitors the system 150 for a pattern of invalid defects opened by a tester based on a predetermined number, which implies the tester needs training. Further, the condition change module 131 monitors system 150 for instances where a new team member is assigned to one of the tools of the system 150. Likewise, the condition change module 131 monitors system 150 for instances where a team member changes a role within the development team associated with the system 150. Each of the above examples represent a change in the condition or state of the software development lifecycle management system 150 (e.g. working environment) that may require new education or training for the associated team members. As will be explained herein, the new education or training is tailored to resolve specific skill gaps custom to each team member, optionally classified by the role of the team member.

By way of another example, the condition change module 131 monitors an organization's technical support division for an addition of a new team member to the technical support division. The condition change module 131 detects the newly added team member which triggers content retrieval and skill gap analysis as described in greater detail infra. The condition change module 131 monitors the technical support's work order ticket management system for a pattern of prematurely closed tickets assigned to a certain technical support member based on a predetermined time between opening and closing of tickets pertaining to a specific technical area, which implies the technical support team member may need training to ensure that a ticket is not closed prematurely. Similarly, the condition change module 131 monitors the technical support's work order ticket management system for a pattern of delayed closing of tickets assigned to a certain technical support member based on a predetermined time between opening and closing of tickets pertaining to a specific technical area, which implies the technical support team member may need training to ensure that a ticket is closed in a timely manner. Further, the condition change module 131 monitors the technical support division for instances where a team member changes a role within the technical support team. Each of the above examples represent a change in the condition or state of the technical support division (e.g. working environment) that may require new education or training for the associated team members. As will be explained herein, the new education or training is tailored to resolve specific skill gaps custom to each team member, optionally classified by the role of the team member.

The content retrieval module 132 includes one or more components of hardware and/or software program code for retrieving educational content relevant to an educational category of the change in condition. For instance, in response to identifying a condition change to the working environment 150, the content retrieval module 132 accesses the educational content database 116 to obtain one or more pieces of educational content that could potentially be included in the customized education plan provided to one or more teams members of the working environment 150. As a function of the content retrieval, the content retrieval module 132 analyzes the change in condition to extract one or more keywords that are used to determine the educational category that correlates to the change in condition. For example, the content retrieval module 132 analyzes the specifics of a new software requirement, defect pattern, role change, or personal profile of a newly added user along with job requirements/minimum training for the role being fulfilled by the new user. The keywords can be determined from tags, content analysis of critical words, headlines, descriptions, and structured fields of data entry, etc.

The content retrieval module 132 analyzes a content of the condition change (e.g. new requirement) to determine a topic or category of the condition change. For instance, the content retrieval module 132 analyzes, reviews, scans, parses, examines, etc. the content of the condition change to determine a topic, technical category, type of role change, etc. of the condition change. The content retrieval module 132 may first determine a type of content of the condition change. For example, the content retrieval module 132 determines whether the content of the interaction is text, a photograph, a video, a digital file, and the like. The type of content determines which type of analyzation technique is used to determine the content of the condition change. If the type of content of the interaction is text, the content retrieval module 132 uses at least one a natural language processing technique, a sentiment analyzer, a topic analyzer, an insight engine, and the like. If the type of content of the interaction is a photograph or a video, the content retrieval module 132 uses an image recognition engine, a visual insights engine, and the like. Further, as a result of the text analysis and image recognition engine techniques to determine the topic of the condition change, the content retrieval module 132 may extract one or more keywords that define or otherwise correspond to the topic/category/educational category of the condition change. For example, the content retrieval module 132 may analyze, parse, or otherwise process the results of the text analysis and the visual recognition engine to extract one or more keywords.

By way of example, the content retrieval module 132 extracts “applications,” “servlets,” and “3.1” as plurality of keywords associated with the determined topic of a new requirement that involves developing applications with servlets 3.1. In another example, the content retrieval module 132 extracts “new,” “team member,” and “tester” as plurality of keywords associated with the determined topic of a new team member joining the software development team as a tester.

Accordingly, the content retrieval module 132 retrieves educational content relevant to an educational category of the change in condition, as determined by extracting and analyzing keywords. The content retrieval module 132 searches the educational content database 116 for relevant educational content for possible inclusion into the customized educational plan for a team member. Additionally, the content retrieval module 132 optionally searches the Internet for relevant content as well as external sources 112 for relevant and useful content. The retrieved educational content that is relevant to the condition change is later filtered based on skill gap (e.g. an educational need) of a particular team member and potentially a role of the team member.

With continued reference to FIG. 1, the skill gap module 133 includes one or more components of hardware and/or software program code for calculating a skill gap of a team member associated with the working environment 150. As an example, the skill gap module 133 calculates a skill gap of a team member of a software development team operating the software development lifecycle management system 152. The skill gap module 133 compares an existing educational training received by the team member relevant to the educational category with the educational content retrieved in response to identifying the change in condition. For instance, once the list of educational content is found based on the condition change, the skill gap module 133 determines custom education requirements for each team member by calculating a skill gap associated with the team members. The skill gap module 133 may check or otherwise communicate with the management system 113 and/or the profiles database to obtain personal and professional data of the individual team member to determine a current skill level of the team member. The personal and professional data includes previous training or education received while a team member was a member of the team within the working environment 150 (e.g. employee training), a degree of training the team member received on a topic, years of experience, a number of role changes, a number of years in the current role on the team, external technical seminars attended, past achievements, job performance evaluations conducted by management of the organization, self-reported training sessions, on-the-job training sessions attended/completed, work history, various different applications and tools used, and the like. The overall assessment of the personal and professional data as it relates to the determined category is referred to as the existing educational training received by the team member. The existing educational training received by the team member can be represented as an overall score, a level, a rank, and the like, of a particular category or topic.

The skill gap module 133 calculates and/or detects areas of need (i.e. a skill gap) between the retrieved educational content and the existing educational training the particular team member has already received. The areas of need are determined by gaps or differences between the educational content retrieved to improve a knowledge of the team member and the education and training the team member has already received. For example, if the team member has received extensive training on developing applications with servlets, and the retrieved educational content relates to basic training on developing applications with servlets, the skill gap is zero or non-existent. As a result, the team member would not likely need to receive additional training in developing applications with servlets. In another example, if the team member has never received training on developing applications with servlets, and the retrieved educational content relates to advanced training on developing applications with servlets, the skill gap is very high. As a result, the team member would need to receive extensive training in developing applications with servlets. In another example, if the team member has received basic level training on developing applications with servlets, and the retrieved educational content relates to advanced training on developing applications with servlets, the skill gap is moderate. As a result, the team member would need to receive additional more advanced training in developing applications with servlets. In each of these examples, the required education for each team member various because the skill level of each team member is considered when developing a custom education training plan.

By way of an additional example, if the team member has received extensive training on troubleshooting a functioning of a refrigerator ice maker, and the retrieved educational content relates to basic training on troubleshooting a functioning of a refrigerator ice maker, the skill gap is zero or non-existent. As a result, the team member would not likely need to receive additional training in troubleshooting a functioning of a refrigerator ice maker. In another example, if the team member has never received training on troubleshooting a functioning of a refrigerator ice maker, and the retrieved educational content relates to advanced training on troubleshooting a functioning of a refrigerator ice maker, the skill gap is very high. As a result, the team member would need to receive extensive training in troubleshooting a functioning of a refrigerator ice maker. In another example, if the team member has received basic level training on troubleshooting a functioning of a refrigerator ice maker, and the retrieved educational content relates to advanced training on troubleshooting a functioning of a refrigerator ice maker, the skill gap is moderate. As a result, the team member would need to receive additional more advanced training in troubleshooting a functioning of a refrigerator ice maker. In each of these examples, the required education for each team member various because the skill level of each team member is considered when developing a custom education training plan.

The education plan module 134 includes one or more components of hardware and/or software program code for building a custom education plan to resolve the skill gap of the team member. For instance, the education plan module 134 builds and/or generates a customized education plan based on the skill gap between the current skill level of the team member and the skill or education required to adapt to the condition change in the working environment 150 (e.g. software development lifecycle management system 152). The education plan module 134 selects educational content out of the retrieved educational content that most effectively and efficiently resolves the skill gap calculated for each team member. Each education plan generated by the education content module 134 is unique to the skills of the team member, such that the education plan is custom built for the team member, based on the condition change.

By way of example, if a new team member joins a software development team as a tester, and the new team member has zero years of experience as a tester using a specific testing tool of the system 152, the computing system 120 determines a level of skill required to be a tester for a given software project and compares the required skill level with the skill level of the new team member. The education module 134 builds a custom education plan that includes training and education for improving the skills of a tester as required by the given software project.

Additionally, the education plan module 134 optionally classifies the educational content by a role of the team member. For example, if the education content retrieved that is relevant to the condition change is about developing applications with servlets, then the education plan module 134 determines that the custom education plan should be assigned to a developer of a software development team. If the education content retrieved that is relevant to the condition change is about testing servlets using a tester software, then the education plan module 134 determines that the custom education plan should be assigned to a tester of the development team. Accordingly, the education plan module 134 filters the educational content and/or the education plan to provide the appropriate content that is relevant to the role of the team member.

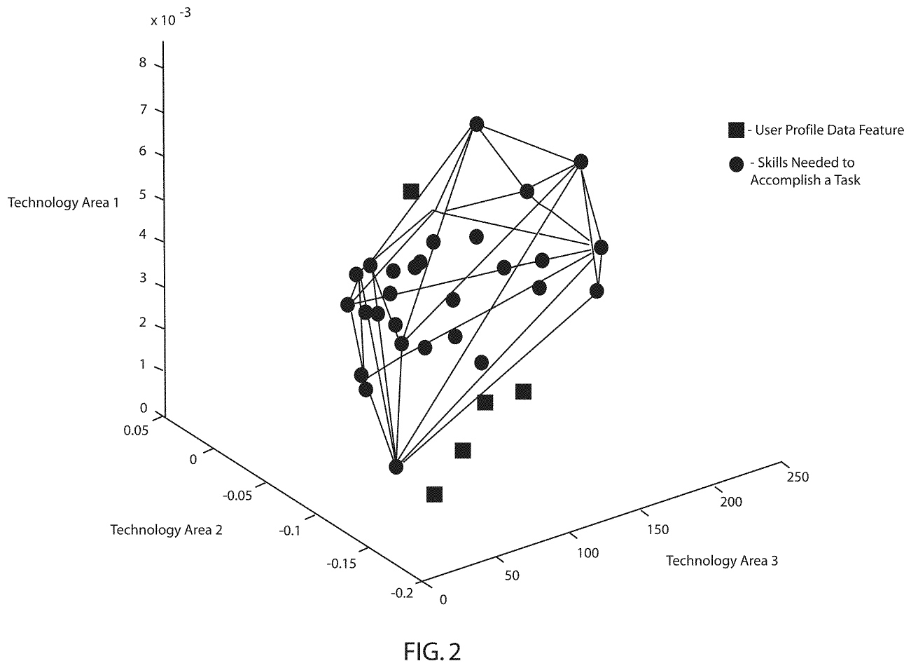

FIG. 2 depicts a diagram plotting user profile features and skills needed to accomplish a task, in accordance with embodiments of the present invention. Using the illustrated diagram, the education plan module 134 builds a custom education plan starting with aggregation of data from three sources: (i) user specific profile and performance data (e.g. from profiles database), (ii) task specific data and metadata from the tools of the working environment 150 (e.g. requirements, test cases, defects, source code, patterns, work order tickets, sales numbers, etc., and (iii) education repository data (e.g. data/content from educational content database 116). The data extracted from these three sources undergo latent semantic analysis, and clustering of text features, as well as other unstructured and structured data from performance, complexity measures, and time associated with the utilization of the data. These features then define three feature spaces that can undergo regularization in order to relate regions of one space with another. Regularization achieves sparse-conjunctive feature spaces which can then be compared. In the exemplary three-way conjunction of elementary features, traversing regions of the user profile that are weakly represented, to examine if these regions correspond to task specific regions. If so, the educational resource may be mapped from that region into the educational repository data space. For example, the illustrated diagram shows how user profile data features, plotted as rectangles, create a convex hull in the regularized feature space. Skills needed to accomplish a task are plotted as circles, and some fall outside the convex hull of user proficiency. These points may then be clustered and cluster centroids compared to the educational material feature space to find the materials ideally suited for user training. Therefore, educational materials are localized to the point nearest the centroid of the outlier requirement feature points, or are viewed as a direction in feature space that can be augmented and shaped by a set of educational material aimed at expanding the hull of user competencies.

Various tasks and specific functions of the modules of the computing system 120 may be performed by additional modules, or may be combined into other module(s) to reduce the number of modules. Further, an embodiment of the computer or computer system 120 comprises specialized, non-generic hardware and circuitry (i.e., specialized discrete non-generic analog, digital, and logic-based circuitry) (independently or in combination) particularized for executing only methods of the present invention. The specialized discrete non-generic analog, digital, and logic-based circuitry includes proprietary specially designed components (e.g., a specialized integrated circuit, such as for example an Application Specific Integrated Circuit (ASIC), designed for only implementing methods of the present invention).

Furthermore, the educational content generation system 100 dynamically builds an education plan or curriculum in response to technical effects or changes to a working environment 150 (e.g. a software development lifecycle management system 150) to improve the skills of the team members (e.g. a software development team). The education plans are individualized to each team member based on a plurality of dynamic variables that include a current skill level, a role of the team member, and a specific technical change to a condition or state of the working environment 150. The dynamic variables change for each application of the educational content generation system 100. Moreover, the education content generation system 100 provides a technical solution by building individualized education plans to improve a functioning a working environment, such as a software development and operations environment. In this example, the educational content generation system 100 increases a quality of the software development team by targeting known deficiencies or defects as a function of defining precise skill gaps of team members and resolving the skill gaps. Implementing the educational content generation system 100 in software development lifecycle management systems results in software development teams being able to automate the process to creating continued education and skill development.

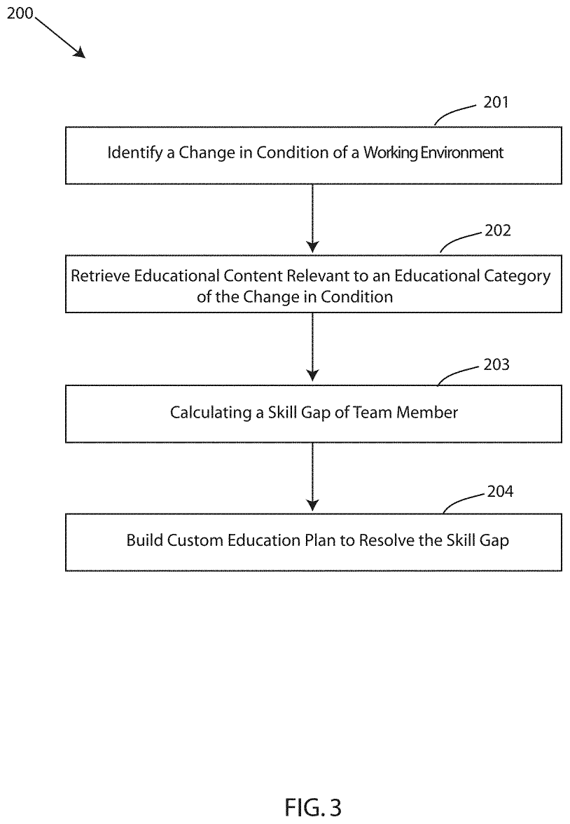

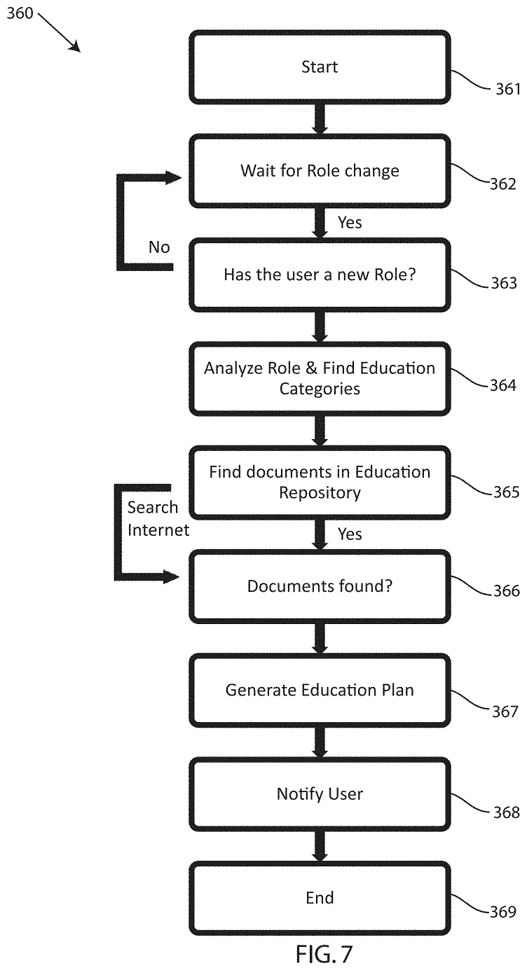

Referring now to FIG. 3, which depicts a flow chart of a method 200 for building customized educations plans to resolve specific skill gaps, in accordance with embodiments of the present invention. One embodiment of a method 200 or algorithm that may be implemented for building customized educations plans to resolve specific skill gaps with the educational content generation system 100 described in FIG. 1 using one or more computer systems as defined generically in FIG. 7 below, and more specifically by the specific embodiments of FIG. 1.

Embodiments of the method 200 for building customized educations plans to resolve specific skill gaps, in accordance with embodiments of the present invention, may begin at step 201 wherein step 201 identifies a change in condition of a working environment. Step 202 retrieves educational content relevant to an educational category or topic of the change in condition. Step 203 calculates a skill gap of a team member associated with the working environment. Step 204 builds a custom education plan to resolve the skill gap of the team member and improve the overall working environment.

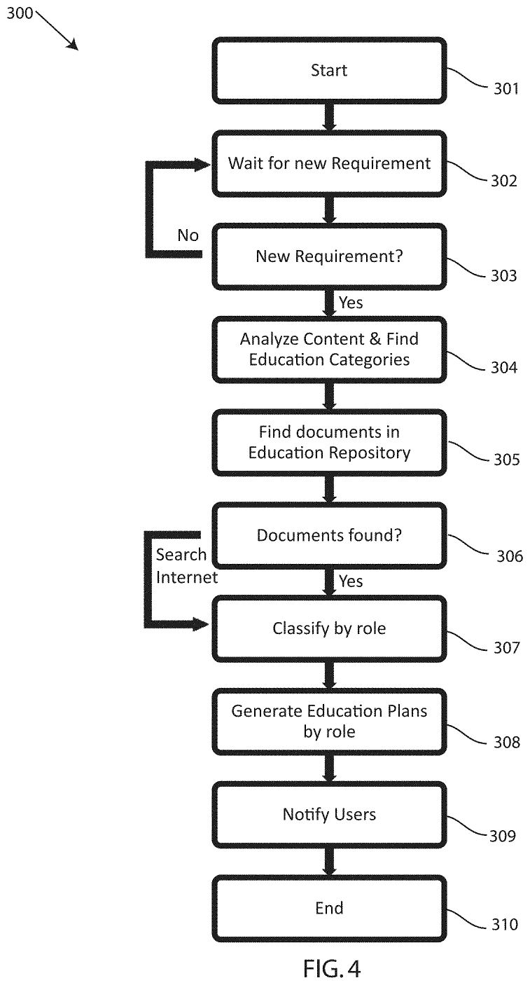

FIG. 4 depicts a flow chart of a method 300 for building customized educations plans to resolve specific skill gaps in software development teams in response to a first change in condition to a software development lifecycle management system, in accordance with embodiments of the present invention. In the illustrated embodiment, the change in condition is a new software requirement added to the SDLC management system. Step 301 starts the method. At step 302, the system is monitoring the SDLC management system for new software requirements. Step 303 determines whether a new software requirement has been added to the system. If no, then the method 300 returns to step 302. If yes, step 304 analyzes content and finds education categories. Step 305 locates educational documents stored in an education repository. Step 306 determines whether educational documents are found. If no, then method 300 returns to step 306 and searches for educational documents. If yes, step 307 classifies the educational documents by role of team member. Step 308 generates an education plan by role. Step 309 notifies users and the method ends at step 310.

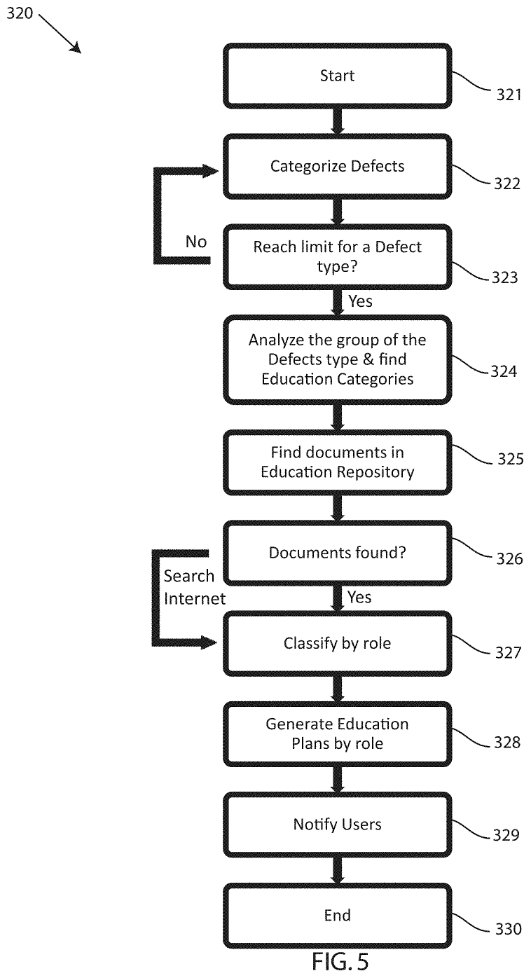

FIG. 5 depicts a flow chart of a method 320 for building customized educations plans to resolve specific skill gaps in software development teams in response to a second change in condition to a software development lifecycle management system, in accordance with embodiments of the present invention. In the illustrated embodiment, the change in condition is a detected defect pattern. Step 321 starts the method. At step 322, the system is categorizing defects in the system 150. Step 323 determines whether a limit has been reached for a defect type. If no, then the method 320 returns to step 322. If yes, step 324 analyzes the group of defect types and determines the educational categories for needed education content. Step 325 locates educational documents stored in an education repository. Step 326 determines whether educational documents are found in depository. If no, then method 320 searches the Internet for educational documents. If yes, step 327 classifies the educational documents by role of team member. Step 328 generates an education plan by role. Step 329 notifies users and the method ends at step 330.

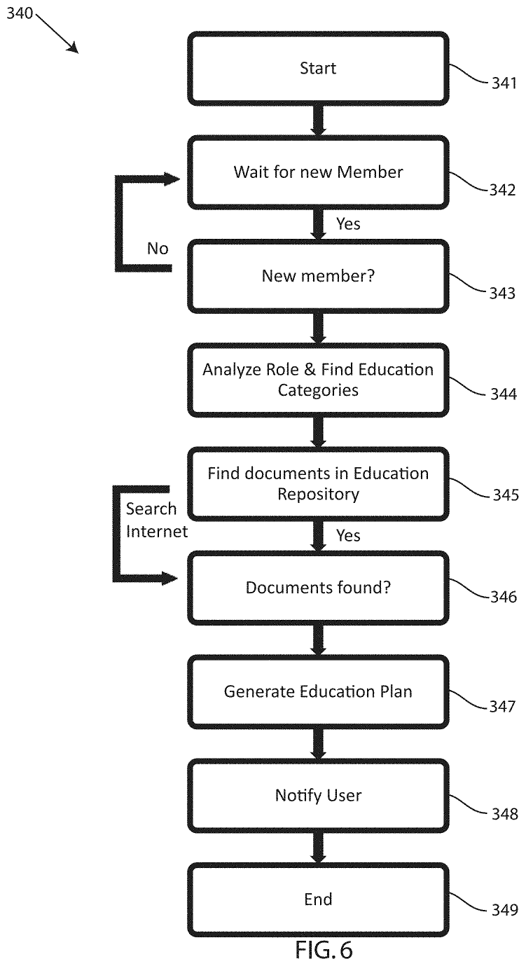

FIG. 6 depicts a flow chart of a method 340 for building customized educations plans to resolve specific skill gaps in software development teams in response to a third change in condition to a software development lifecycle management system, in accordance with embodiments of the present invention. In the illustrated embodiment, the change in condition is the addition of a new team member to the SDLC management system. Step 341 starts the method. At step 342, the system monitors the system 150 for an addition of a new member to the team. Step 343 determines whether a new member has been added to the team. If no, then the method 340 returns to step 342. If yes, step 344 analyzes the role of the new member and determines the educational categories for needed education content. Step 345 locates educational documents stored in an education repository. Step 346 determines whether educational documents are found in depository. If no, then method 340 searches the Internet for educational documents. If yes, step 347 generates a custom education plan. Step 348 notifies users and the method ends at step 349.

FIG. 7 depicts a flow chart of a method 360 for building customized educations plans to resolve specific skill gaps in software development teams in response to a fourth change in condition to a software development lifecycle management system, in accordance with embodiments of the present invention. In the illustrated embodiment, the change in condition is a role change in the software development team associated with the SDLC management system. Step 361 starts the method. At step 362, the system monitors the system 150 for a role change to an existing team member. Step 363 determines whether a role change has occurred. If no, then the method 360 returns to step 362. If yes, step 364 analyzes the role and determines the educational categories for needed education content. Step 365 locates educational documents stored in an education repository. Step 366 determines whether educational documents are found in depository. If no, then method 360 searches the Internet for educational documents. If yes, step 367 generates a custom education plan. Step 368 notifies users and the method ends at step 369.

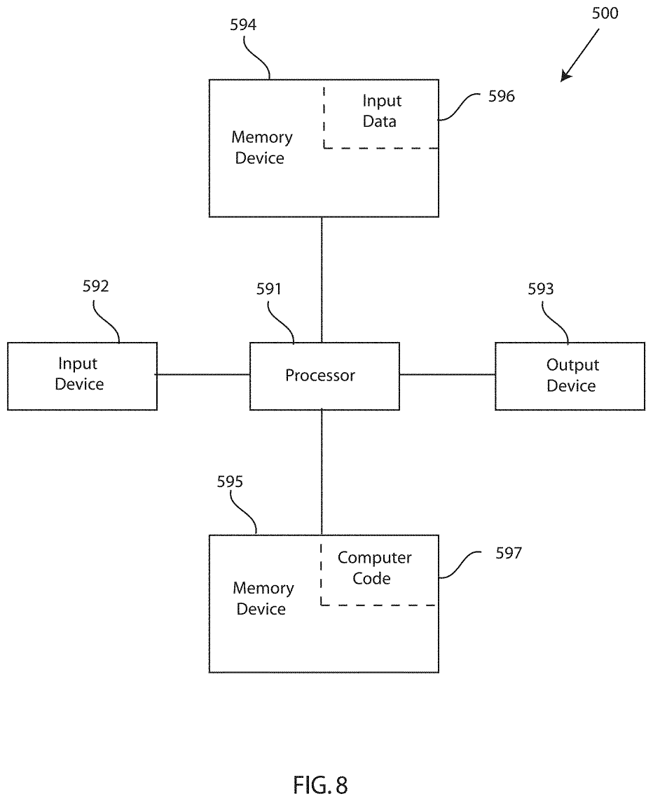

FIG. 8 depicts a block diagram of a computer system for the educational content generation system 100 of FIG. 1, capable of implementing a method for building customized educations plans to resolve specific skill gaps of FIGS. 3-7, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer system 500, including executing instructions included in the computer code 597 for the tools and programs capable of implementing a method for building customized educations plans to resolve specific skill gaps in the manner prescribed by the embodiments of FIGS. 3-7 using the educational content generation system 100 of FIG. 1, wherein the instructions of the computer code 597 may be executed by processor 591 via memory device 595. The computer code 597 may include software or program instructions that may implement one or more algorithms for implementing the method for building customized educations plans to resolve specific skill gaps, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer-readable program embodied therein and/or having other data stored therein, wherein the computer-readable program comprises the computer code 597. Generally, a computer program product (or, alternatively, an article of manufacture) of the computer system 500 may comprise said computer usable storage medium (or said program storage device).

Memory devices 594, 595 include any known computer-readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 8.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the touchscreen of a computing device. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to building customized educations plans to resolve specific skill gaps. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer system 500) including one or more processor(s) 591, wherein the processor(s) carry out instructions contained in the computer code 597 causing the computer system to build customized educations plans to resolve specific skill gaps. Another embodiment discloses a process for supporting computer infrastructure, where the process includes integrating computer-readable program code into a computer system 500 including a processor.

The step of integrating includes storing the program code in a computer-readable storage device of the computer system 500 through use of the processor. The program code, upon being executed by the processor, implements a method for building customized educations plans to resolve specific skill gaps. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for building customized educations plans to resolve specific skill gaps.

A computer program product of the present invention comprises one or more computer-readable hardware storage devices having computer-readable program code stored therein, said program code containing instructions executable by one or more processors of a computer system to implement the methods of the present invention.

A computer system of the present invention comprises one or more processors, one or more memories, and one or more computer-readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

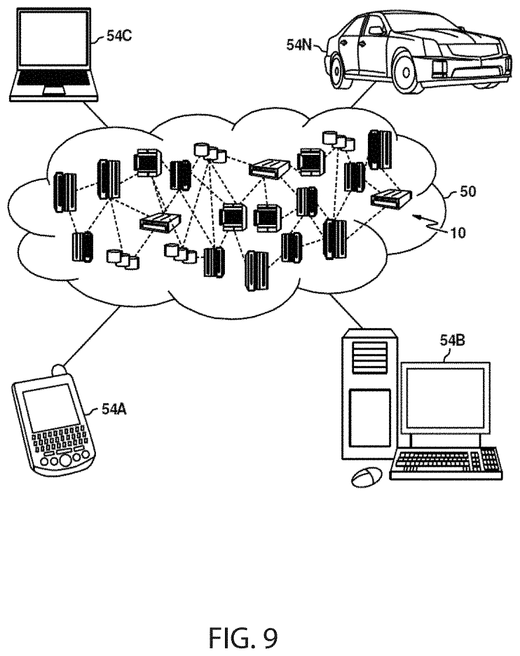

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 9 are intended to be illustrative only and that computing nodes 10 and cloud computing environment 50 can communicate with any type of computerized device over any type of network and/or network addressable connection (e.g., using a web browser).

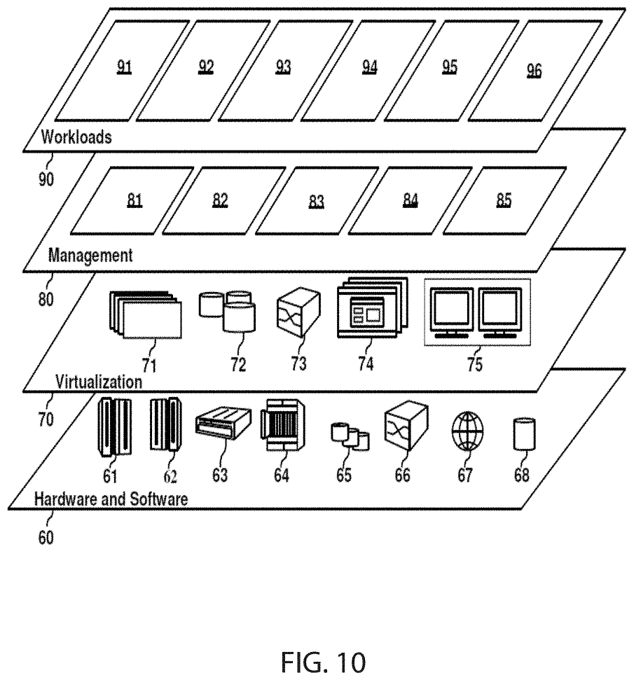

Referring now to FIG. 10, a set of functional abstraction layers provided by cloud computing environment 50 (see FIG. 9) are shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and customized education plan building 96.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
identifying, by a processor of a computing system, a change in condition of a working environment;
retrieving, by the processor, educational content relevant to an educational category of the change in condition;
calculating, by the processor, a skill gap of a team member associated with the working environment, by comparing an existing educational training received by the team member relevant to the educational category with the educational content retrieved in response to identifying the change in condition; and
building, by the processor, a custom education plan to resolve the skill gap of the team member.

2. The method of claim 1, wherein the retrieving includes analyzing, by the processor, the change in condition to extract one or more keywords that are used to determine the educational category that correlates to the change in condition.

3. The method of claim 2, wherein the keywords are determined from tags, content analysis of critical words, headlines, descriptions, and structured fields of data entry.

4. The method of claim 1, further comprising: classifying, by the processor, the educational content by a role of the team members, wherein the custom education plan filters the educational content to provide the user with educational content relevant to the role of the team member.

5. The method of claim 1, wherein the calculating the skill gap comprises accessing a personal data management system maintaining records of the team members and analyzing the existing educational training to determine a current skill level of the team member.

6. The method of claim 1, wherein the change of condition includes a new requirement, a pattern, an addition of a new team member, and a role change within the working environment.

7. The method of claim 1, further comprising: modifying, by the processor, the custom education plan over time based on feedback received from the team member and other team members that have utilized the custom education plan.

8. A computing system, comprising:
a processor;
a memory device coupled to the processor; and
a computer readable storage device coupled to the processor, wherein the storage device contains program code executable by the processor via the memory device to implement a method comprising:
identifying, by a processor of a computing system, a change in condition of a working environment;
retrieving, by the processor, educational content relevant to an educational category of the change in condition;
calculating, by the processor, a skill gap of a team member of associated with the working environment, by comparing an existing educational training received by the team member relevant to the educational category with the educational content retrieved in response to identifying the change in condition; and
building, by the processor, a custom education plan to resolve the skill gap of the team member.

9. The computing system of claim 8, wherein the retrieving includes analyzing, by the processor, the change in condition to extract one or more keywords that are used to determine the educational category that correlates to the change in condition.

10. The computing system of claim 9, wherein the keywords are determined from tags, content analysis of critical words, headlines, descriptions, and structured fields of data entry.

11. The computing system of claim 8, further comprising: classifying, by the processor, the educational content by a role of the team members, wherein the custom education plan filters the educational content to provide the user with educational content relevant to the role of the team member.

12. The computing system of claim 8, wherein the calculating the skill gap comprises accessing a personal data management system maintaining records of the software development team and analyzing the existing educational training to determine a current skill level of the team member.

13. The computing system of claim 8, wherein the change of condition includes a new requirement, a pattern, an addition of a new team member, and a role change.

14. The computing system of claim 8, further comprising: modifying, by the processor, the custom education plan over time based on feedback received from the team member and other team members that have utilized the custom education plan.

15. A computer program product, comprising a computer readable hardware storage device storing a computer readable program code, the computer readable program code comprising an algorithm that when executed by a computer processor of a computing system implements a method comprising:
identifying, by a processor of a computing system, a change in condition of a working environment;
retrieving, by the processor, educational content relevant to an educational category of the change in condition;
calculating, by the processor, a skill gap of a team member associated with the working environment, by comparing an existing educational training received by the team member relevant to the educational category with the educational content retrieved in response to identifying the change in condition; and
building, by the processor, a custom education plan to resolve the skill gap of the team member.

16. The computer program product of claim 15, wherein the retrieving includes analyzing, by the processor, the change in condition to extract one or more keywords that are used to determine the educational category that correlates to the change in condition, further wherein the keywords are determined from tags, content analysis of critical words, headlines, descriptions, and structured fields of data entry.

17. The computer program product of claim 15, further comprising: classifying, by the processor, the educational content by a role of the team, wherein the custom education plan filters the educational content to provide the user with educational content relevant to the role of the team member.

18. The computer program product of claim 15, wherein the calculating the skill gap comprises accessing a personal data management system maintaining records of the software development team and analyzing the existing educational training to determine a current skill level of the team member.

19. The computer program product of claim 15, wherein the change of condition includes a new requirement, a pattern, an addition of a new team member to the software development team, and a role change within the software development team.

20. The computer program product of claim 15, further comprising: modifying, by the processor, the custom education plan over time based on feedback received from the team member and other team members that have utilized the custom education plan.
